(19) United States
(12) Patent Application Publication
(10) Pub. No.: US 2012/0032791 A1
(43) Pub. Date: Feb. 9, 2012

(54) Vehicle-use obstacle detection apparatus

(75) Inventors: Kenichirou Horikawa, Hamamatsu-shi (JP); Kunikazu Nakayama, Nagoya (JP)

(73) Assignee: DENSO CORPORATION, Kariya-city (JP)

(21) Appl. No.: 13/136,482

(22) Filed: Aug. 2, 2011

(30) Foreign Application Priority Data
Aug. 3, 2010 (JP) 2010-174187

(51) Int. Cl. B60Q 1/00

(52) U.S. Cl. 340/435

(57) ABSTRACT

The vehicle-use obstacle detection apparatus having a plurality of obstacle detection sensors installed at different places of a vehicle is configured to control a voice warning device such that, when two or more of the obstacle detection sensors have detected obstacles in succession, voice messages indicative of directions in which the detected obstacles are present respectively are outputted in succession in ascending order of value of the obstacle distance.

This application claims priority to Japanese Patent Application No. 2010-174187 filed on Aug. 3, 2010, the entire contents of which are hereby incorporated by reference.

### BACKGROUND OF THE INVENTION

1. Field of the Invention

The present invention relates to a vehicle-use obstacle detection apparatus having a voice warning function for outputting a warning by voice in accordance with the position of a detected obstacle.

2. Description of Related Art

There is known a vehicle-use obstacle detection apparatus constituted of four ultrasonic sensors disposed at different places of a vehicle, and configured to transmit an ultrasonic wave and receive the ultrasonic wave reflected from an obstacle, a processing section that calculates the distance to the detected obstacle based on ultrasonic waves transmitted and received by the ultrasonic sensors, a voice warning section that outputs a warning voice message regarding the direction of the obstacle when the distance to the obstacle becomes smaller than a predetermined distance, and a control means to control the voice warning section. For example, refer to Japanese Patent No. 3550322.

The vehicle-use obstacle detection apparatus described in this patent document performs a voice guidance message output operation as shown in the flowchart of FIG. 8. If, of four ultrasonic sensors, the one disposed at a front right part of a vehicle detects an obstacle in step S101, a voice message “Front right side” is outputted in step S102. If another ultrasonic sensor, for example, the one disposed at a back right part of the vehicle detects an obstacle subsequently in step S103 while the front right ultrasonic sensor is detecting the obstacle, a voice message “Right side” is outputted in step S104 to inform that the area in which the objects detected by these ultrasonic sensors exist is wider than the area in which the obstacle detected by the front right ultrasonic sensor exists.

As explained above, the vehicle-use obstacle detection apparatus described in the patent document is configured such that if the number of the ultrasonic sensors that have detected an obstacle increases, a voice message to inform that obstacles exists in a wide area is outputted. However, this configuration has a problem in that the vehicle driver or passenger cannot determine to which direction attention should be paid most, and accordingly the burden of watching the wide area is placed on the vehicle driver.

### SUMMARY OF THE INVENTION

An embodiment provides a vehicle-use obstacle detection apparatus comprising:

a plurality of obstacle detection sensors installed at different places of a vehicle, each of the obstacle detection sensors being configured to transmit an ultrasonic wave, receive a reflected version of the ultrasonic wave, and output a detection signal indicative of the reflected version having been received;

a distance calculation means to calculate a distance to a detected obstacle as an obstacle distance based on the detection signal for each of the obstacle detection sensors;

a voice warning device to output information by voice indicative of a direction in which the detected obstacle is present when the obstacle distance is smaller than a predetermined distance;

a control means to control the voice warning device; and

a storage means to store the obstacle distance calculated by the distance calculation means together with identification information identifying the obstacle detection sensor that has outputted the detection signal based on which the obstacle distance has been calculated,

wherein

the control means is configured to control the voice warning device such that, when two or more of the obstacle detection sensors have detected obstacles in succession, voice messages indicative of directions in which the detected obstacles are present respectively are outputted in succession in ascending order of value of the obstacle distance.

According to the present invention, there is provided a vehicle-use obstacle detection apparatus that can inform a vehicle driver of presence of a plurality of obstacles with less burden of caution placed on the vehicle driver.

Other advantages and features of the invention will become apparent from the following description including the drawings and claims.

### BRIEF DESCRIPTION OF THE DRAWINGS

In the accompanying drawings:

FIG. 1 is a cross-sectional view of an ultrasonic sensor for use in a vehicle-use obstacle detection apparatus according to an embodiment of the invention;

FIG. 2 is a diagram for explaining the disposition and sensing areas of the ultrasonic sensors shown in FIG. 1 mounted on a vehicle;

FIG. 3 is a block diagram showing the structure of the vehicle-use obstacle detection apparatus according to the embodiment of the invention;

FIG. 4 is a flowchart showing a warning process performed by a control circuit included in the vehicle-use obstacle detection apparatus shown in FIG. 3;

FIG. 5 is a flowchart showing a voice guidance message output operation carried out in step S5 shown in FIG. 4;

FIG. 6 is a diagram showing an example of waveforms of ultrasonic waves U1 and U2 respectively transmitted from and received by one of the ultrasonic sensors;

FIG. 7 is a diagram showing an example of the voice guidance messages outputted when two or more of the ultrasonic sensors detect obstacles; and

FIG. 8 is a flowchart showing a voice guidance message output operation carried out by a conventional vehicle-use obstacle detection apparatus.

### PREFERRED EMBODIMENTS OF THE INVENTION

### First Embodiment

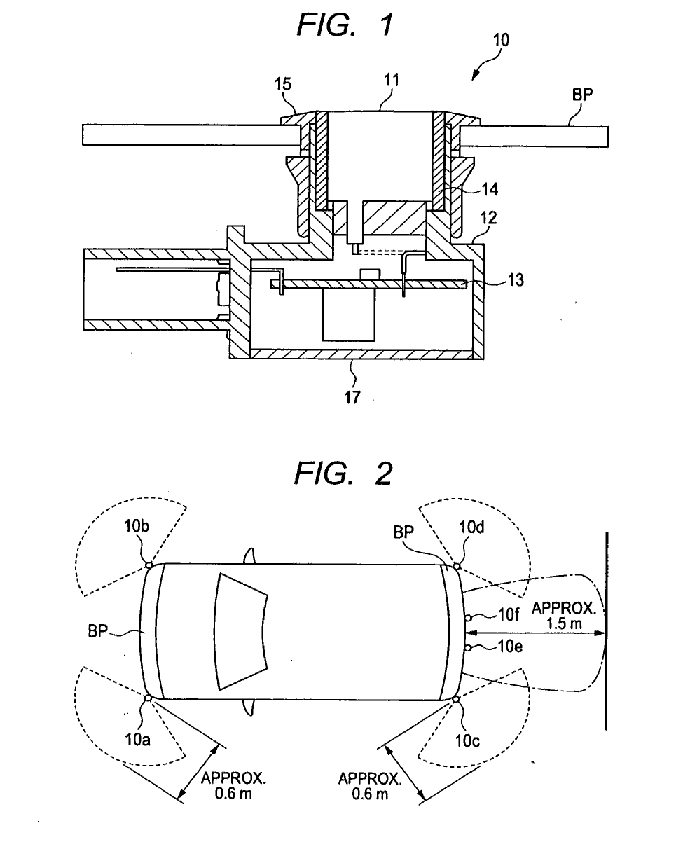

FIG. 1 shows an ultrasonic sensor unit 10 as an obstacle detection sensor (referred to simply as an ultrasonic sensor hereinafter) used in a vehicle-use obstacle selection apparatus 1. The ultrasonic sensor 10 is a two way sensor which transmits an ultrasonic wave by vibrating a piezo ceramic vibrator using piezoelectric effect, and transducers an ultrasonic wave incident to the piezo ceramic vibrator into an electric signal. The ultrasonic sensor 10 includes an ultrasonic microphone 11, a case 12 having an integrated connector 12 and a control circuit board 13.

The ultrasonic microphone 11, which accommodates the piezo ceramic vibrator, is housed in the case 12 through a cushion member 14.

The case 12 is integrally assembled to a bumper BP of the vehicle through a vessel 15 with a brim having a circular ring shape through a spring member (not shown). The case 12 is sealed by a cover 17 with the ultrasonic microphone 11, the control circuit board 13 and a filling material (urethane, for example) housed therein.

The control circuit board 13 includes a wave transmission circuit, a wave reception circuit, a waveform shaping circuit, a distance calculation circuit and a communication circuit. The wave transmission circuit, which is a circuit for transmitting an ultrasonic wave, includes an oscillation circuit which generates an ultrasonic signal of a frequency of 66.7 kHz and a drive circuit to drive the piezo ceramic vibrator.

The wave reception circuit, which is a circuit for receiving a reflected version of the ultrasonic wave transmitted from the wave transmission circuit, includes a detection circuit constituted of an operational amplifier. The waveform shaping circuit, which is for shaping an output signal (received ultrasonic wave) of the wave reception circuit, includes a rectifier circuit, a smoothing circuit, a filter circuit and a level determination circuit.

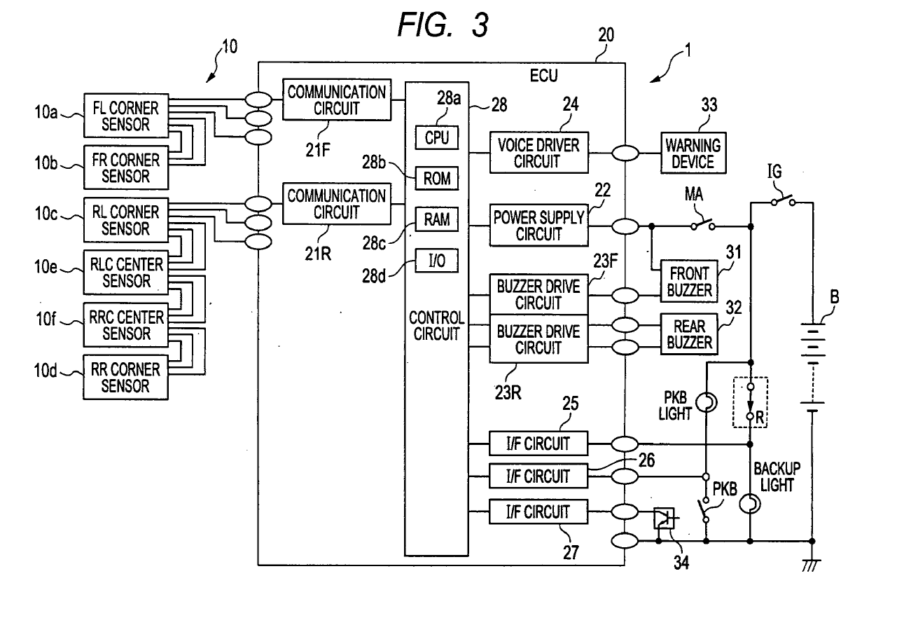

The distance calculation circuit is a circuit which measures the time from when an ultrasonic wave is transmitted by the wave transmission circuit to when a reflected version of the transmitted ultrasonic wave is received by the wave reception circuit based on the output signal of the waveform shaping circuit, and calculates a distance to an obstacle based on the calculated time. The communication circuit is a circuit for transmitting a detection signal (serial signal, for example) indicative of the calculated distance to an ECU 20 (see FIG. 3).

As shown in FIG. 2, The ultrasonic sensors 10 are disposed at two corners of each of the front bumper BP and the rear bumper BP, and at right-center and left-center portions of the rear bumper BP. More specifically, the ultrasonic sensors 10 are mounted as an FL (front left) corner sensor 10a, an FR (front right) corner sensor 10b, an RL (rear left) corner sensor 10c, an RR (rear right) corner sensor 10d, an RLC (rear left-center) center sensor 10e and an RRC (rear right-center) center sensor 10f. In FIG. 2, the sensing areas of the sensors 10a to 10 d are shown by the broken lines, and the sensing area of the sensors 10e and 10f are shown by the chain line.

As shown in FIG. 3, each of the sensors 10a to 10f is provided with a plurality of terminals for a power supply line, a ground line, and communication lines (input and output lines). Some of the terminals of the FL corner sensor 10a are connected to the corresponding terminals of the ECU 20 through signal lines, and the other terminals of the FL corner sensor 10a are connected to the corresponding terminals of the FR corner sensor 10b.

Some of the terminals of the RL corner sensor 10c are connected to the corresponding terminal of the ECU 20 through signal lines, and the other terminals of the RL corner sensor 10c are connected to the corresponding terminals of the RLC center sensor 10e. The terminals of the RLC center sensor 10e other than those connected to the RL corner sensor 10c are connected to the corresponding terminals of the RRC center sensor 10f. The terminals of the RRC center sensor 10f other than those connected to the RLC center sensor 10e are connected to the corresponding terminals of the RR corner sensor 10d.

The ECU 20 includes communication circuits 21F and 21R, a power supply circuit 22, buzzer drive circuits 23F and 23R, a voice driver circuit 24 and various interface circuits 25 to 27.

The communication circuit 21F inputs the detection signals each indicative of a distance to an obstacle received from the FL corner sensor 10a and the FR corner sensor 10b into the control circuit 28. The communication circuit 21R inputs the detection signals each indicative of a distance to an obstacle received from the RL corner sensor 10c, the RR corner sensor 10d, the RLC center sensor 10e and the RRC center sensor 10f into the control circuit 28.

The power supply circuit 22 has a function of generating a constant voltage (5 V in this embodiment) from the battery voltage (the output voltage of a battery B mounted on the vehicle), and is connected to the battery B through a main switch MA and an ignition switch IG. The buzzer drive circuits 23F and 23R respectively drive buzzers 31 and 32 installed in a front part and rear part of the vehicle cabin, respectively such that they emit, as a buzzer sound, short discontinuous sounds (“pip pip pip . . . ”, for example) when the distance to an obstacle is relatively large, emit rapid discontinuous sounds (“pipipipi . . . ”, for example) when the distance is relatively small, and emit continuous sound (“peeee . . . ”, for example) when the distance is very small.

The voice driver circuit 24 has a function of outputting a voice guidance message (“Front right side” or “Back right side”, for example) and a function of outputting a preliminary sound (in this embodiment, electronic sound such as “pong”, or “ching” from a warning device 33 such as a loudspeaker.

The interface circuit 25 is configured to input an R-range (reverse range) detection signal to the control circuit 28 when the transmission of the vehicle is shifted to the R range. The interface circuit 26 is configured to input a P-range (parking range) detection signal to the control circuit 28 when the transmission of the vehicle is shifted to the P range. The interface circuit 27 is configured to input a speed detection signal indicative of the vehicle speed received from a vehicle speed sensor 34 to the control circuit 28. A signal indicative of a parking brake switch of the vehicle being turned on may be used instead of the P-range detection signal in a case where the P-range detection signal is not available.

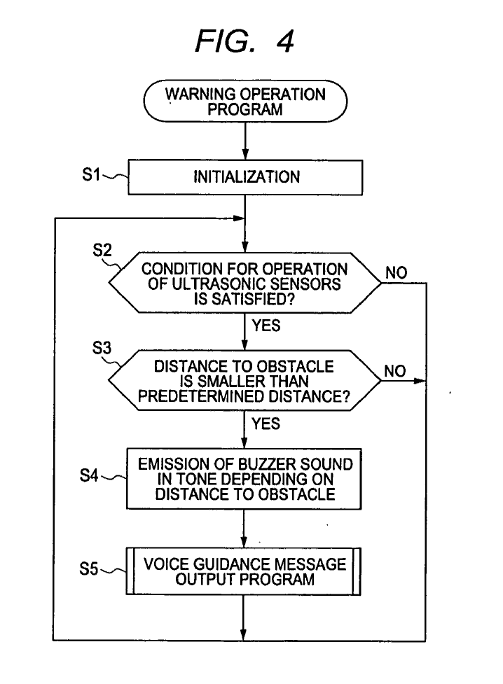

The control circuit 28 is mainly constituted of a CPU 28a, a ROM 28b, a RAM 28c and an I/O 28d. The control circuit 28 performs a waning operation program shown in FIG. 4 and a voice guidance message output program stored in the ROM 28b repeatedly at regular time intervals after the main switch MA and the ignition switch IG are turned on, and output drive signals resulting from performing these programs to the buzzer drive circuits 23F and 23R and the voice driver circuit 24.

Next, the operation of the vehicle-use obstacle detection apparatus 1 having the above described structure is explained. When the vehicle driver turns on the main switch MA and the ignition switch IG, the control circuit 28 starts performing the warning operation program shown in FIG. 4.

This program begins in step S1 by executing an initialization process, and then proceeds to step S2 to determine whether or not a condition for operation of the ultrasonic sensors 10 is satisfied. More specifically, in step S2, when the transmission is in other than the P-range, and the vehicle speed is below a predetermined speed (15 km/h, for example), the detection signals outputted from the corner sensors 10a to 10d are inputted to the control circuit 28. When the transmission is shifted to the R range, in addition to the detection signals outputted from the corner sensors 10a to 10d, the detection signals outputted from the center sensors 10e and 10f are inputted to the control circuit 28.

If the control circuit 28 determines that the respective sensors 10a to 10f are functioning normally, the program proceeds to step S3 where the control circuit 28 determines whether the distance to an object is smaller than or equal to a predetermined distance (0.6 m for the corner sensors 10a to 10d, and 1.5 m for the center sensors 10e and 10f).

For example, in a case where one of the sensors 10a to 10f transmits an ultrasonic wave U1 and receives a reflected version of the ultrasonic wave U1 as an ultrasonic wave U2, and the control circuit 28 determines that the distance to the obstacle is smaller than the predetermined distance based on the ultrasonic waves U1 and U2, the program proceeds to step S4 where the control circuit 28 determines a buzzer sound (selects from among the discontinuous sound, short discontinuous sounds and continuous sound), and outputs a drive signal indicative of the determined buzzer sound to the buzzer drive circuits 23F and 23R. The buzzer 31 and 32 outputs the buzzer sound in accordance with the drive signals received from the buzzer drive circuits 23F and 23R, respectively. After step S4, the voice guidance message output program is carried out in step S5.

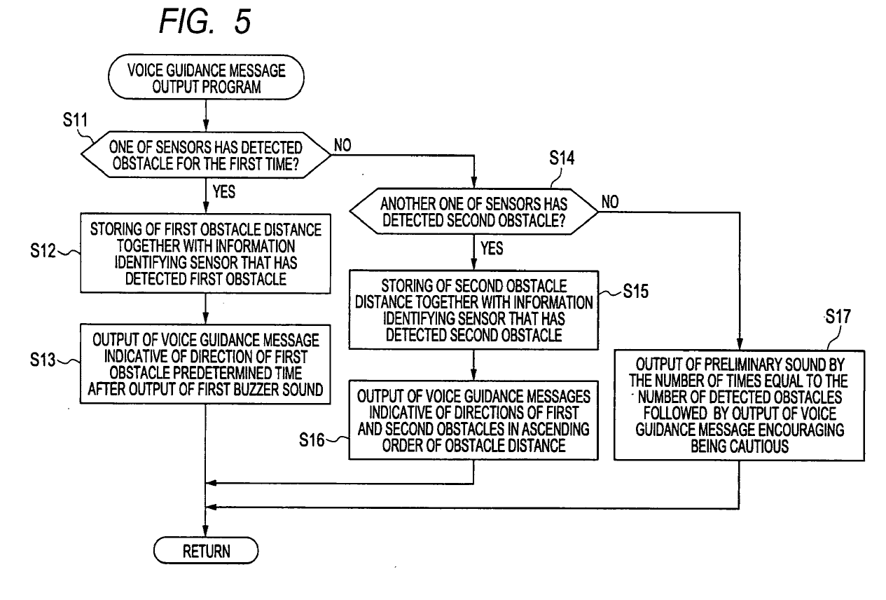

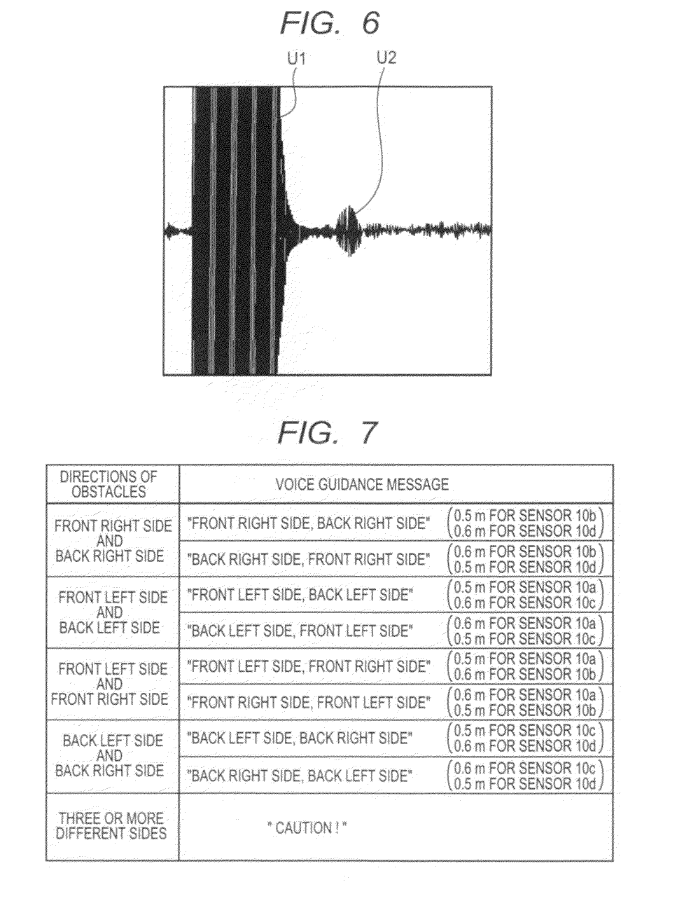

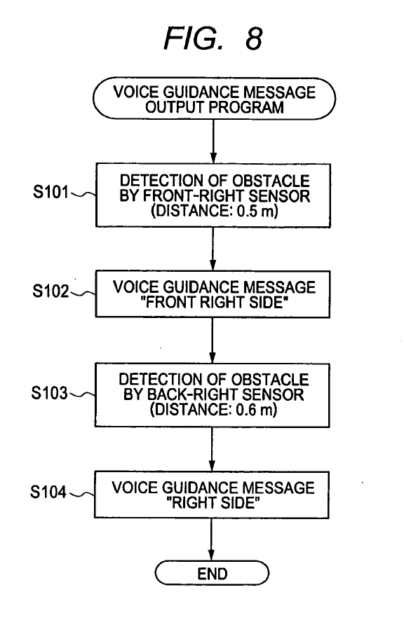

FIG. 5 is a flowchart showing the voice guidance message output program carried out in step S5 of the warning operation program. This program begins in step S11 by determining whether or not the obstacle is detected by only one of the sensors 10a to 10f. If the determination result in step S11 is affirmative, the program proceeds to step S12 where the sensor that has detected the object is associated with the detected obstacle, and the distance to the obstacle measured by this sensor is stored in the RAM 28c as a first distance together with identification information indicative of this sensor identified as a first-to-detect sensor.

Next, the control circuit 28 reads the identification information from the RAM 28c a predetermined time (0.5 seconds, for example) after the buzzer sound is outputted from the buzzers 31 and 32 for the first time (that is, after the first one of the discontinuous sounds is outputted), and outputs the drive signal corresponding to the sensor identified by the identification information to the voice driver circuit 24. The warning device 33 outputs a voice guidance message in accordance with the drive signal received from the voice driver circuit 24 in step S13. For example, when the identification information read from the RAM 28c indicates the corner sensor 10b, the warning device 33 outputs a voice guidance message “Front right side”. For another example, when the identification information read from the RAM 28c indicates the corner sensor 10d, the warning device 33 outputs a voice guidance message “Back right side”.

If the determination result in step S11 is negative, the program proceeds to step S14 to determine whether or not another one of the sensors 10a to 10f has detected another obstacle. If the determination result in step S14 is affirmative, the program proceeds to step S15 where the distance to this another obstacle is stored in the RAM 28c as a second distance together with identification information indicative of this another one of the sensors identified as a second-to-detect sensor.

After completion of step S15, the program proceeds to step S16 where the control circuit 28 to output the preliminary sound twice to inform that two obstacles have been detected, and then outputs drive signals corresponding to the above two sensors in the order from the one the distance detected by which is smaller than the other. By outputting the preliminary sound twice before outputting the voice guidance messages, the vehicle driver can know immediately that two obstacles have been detected in succession.

FIG. 7 is a diagram showing an example of the voice guidance messages. For example, when a first obstacle is detected by the corner sensor 10b, and the distance to the first obstacle is measured as 0.5 m and stored in the RAM 28c, if a second obstacle is detected by the corner sensor 10d, and the distance to the second obstacle is measures as 0.6 m and stored in the RAM 28c, the preliminary sound is outputted twice (“pong pong”, for example), and then the voice guidance messages “Front right side” and “Back right side” are outputted.

If the determination results in steps S11 and S14 are negative, that is, if a third (or more) obstacle is detected, the program proceeds to step S17 where the control circuit 28 outputs the preliminary sound as many times as the number of detected obstacles, and then output the voice guidance message. In this case, the voice guidance message is “Caution!” (see FIG. 7). By outputting such a voice guidance message when three or more obstacles have been detected, it is possible to encourage the vehicle drive to be cautious in driving the vehicle.

As described above, in this embodiment, when two obstacles have been detected and the distances to them are measured as the first and second distances, the voice guidance message corresponding to one of them, the distance to which is smaller than that of the other is outputted, and then the voice guidance message corresponding to the other one is outputted from the warning device 33. That is, according to this embodiment, since the direction in which the nearest obstacle is present is informed first, the vehicle driver can know the direction to which attention should be paid most, and accordingly, burden of caution can be lessened for the vehicle driver.

### Modifications

In the first embodiment, the preliminary sound outputted to inform that two or more obstacles have been detected is one in kind. However, preliminary sounds different in tone may be used according to the number of detected obstacles. In this case, the preliminary sound may be outputted by the number of times equal to the number of detected obstacles in the same tone, or may be outputted for a predetermined time period (1 second, for example) in different tones corresponding to the number of detected obstacles. For example, the above embodiment may be modified such that a bell sound such as “ching” is outputted when two obstacles have been detected, a chime sound such as “pong” is outputted when three obstacles have been detected, and a siren sound such as “woo” is outputted when four obstacles have been detected. According to the above modification the vehicle driver can known intuitively the extent of risk of collision.

Incidentally, in the above embodiment and its modification, when the preliminary sound is outputted three or more times, the output cycle may be shorter than that when the preliminary sound is outputted twice in order to prevent collision more reliably when the vehicle is approaching the obstacle while the preliminary sound is outputted.

In the above embodiment, each ultrasonic sensor 10 calculates a distance to an obstacle. However, the control circuit 28 or ECU 20 may calculate distances to obstacles based on the output signals received from the ultrasonic sensors 10.

The structure to output the preliminary sound before outputting the voice guidance message, and the structure to inform an approximate distance to an obstacle by a buzzer sound may be omitted depending on conditions.

In addition to the warning device 33, there may be provided in the vehicle cabin an indicator having lights disposed at places corresponding to the position of the respective sensors 10a to 10f, each of which lights or blinks when a corresponding one of the sensors detects an obstacle.

In the above embodiment, an ultrasonic sensor is used as a sensors to detect an obstacle. However, the sensor is not limited to one that uses an ultrasonic wave. For example, it may be one that uses an electromagnetic wave.

The above explained preferred embodiments are exemplary of the invention of the present application which is described solely by the claims appended below. It should be understood that modifications of the preferred embodiments may be made as would occur to one of skill in the art.

What is claimed is:

1. A vehicle-use obstacle detection apparatus comprising:
a plurality of obstacle detection sensors installed at different places of a vehicle, each of the obstacle detection sensors being configured to transmit an ultrasonic wave, receive a reflected version of the ultrasonic wave, and output a detection signal indicative of the reflected version having been received;
a distance calculation means to calculate a distance to a detected obstacle as an obstacle distance based on the detection signal for each of the obstacle detection sensors;
a voice warning device to output information by voice indicative of a direction in which the detected obstacle is present when the obstacle distance is smaller than a predetermined distance;
a control means to control the voice warning device; and
a storage means to store the obstacle distance calculated by the distance calculation means together with identification information identifying the obstacle detection sensor that has outputted the detection signal based on which the obstacle distance has been calculated,
wherein
the control means is configured to control the voice warning device such that, when two or more of the obstacle detection sensors have detected obstacles in succession, voice messages indicative of directions in which the detected obstacles are present respectively are outputted in succession in ascending order of value of the obstacle distance.

2. The vehicle-use obstacle detection apparatus according to claim 1, wherein the control means is configured to control the voice warning device such that, when two or more of the obstacle detection sensors have detected obstacles in succession, a preliminary sound indicative of two or more obstacles having been detected is outputted before the voice messages are outputted.

3. The vehicle-use obstacle detection apparatus according to claim 2, wherein the preliminary sound is outputted a number of times equal to the number of the detected obstacles.

4. The vehicle-use obstacle detection apparatus according to claim 2, wherein the preliminary sound is changed in tone depending on the number of the detected obstacles.

5. The vehicle-use obstacle detection apparatus according to claim 1, wherein the control means is configured to control the voice warning device such that, when two of the obstacle detection sensors have detected obstacles in succession, voice messages indicative of directions in which the detected obstacles are present respectively are outputted in succession in ascending order of value of the obstacle distance, and when three of more of the obstacle detection sensors have detected obstacles in succession, a voice message to encourage a vehicle drive to be cautious is outputted.
